(19) United States
(12) Patent Application Publication
(10) Pub. No.: US 2021/0192981 A1
(43) Pub. Date: Jun. 24, 2021

(54) FLEXIBLE COVER PLATE AND FLEXIBLE DISPLAY DEVICE

(71) Applicant: Wuhan China Star Optoelectronics Technology Co., Ltd., Wuhan (CN)

(72) Inventor: Shiyuan Xiao, Wuhan (CN)

(21) Appl. No.: 16/308,478

(22) PCT Filed: Sep. 22, 2018
(86) PCT No.: PCT/CN2018/107142

§ 371 Date: Dec. 9, 2018

(30) Foreign Application Priority Data
Apr. 25, 2018 (CN) 201810380783.9

(51) Int. Cl. G09F 9/30; G06F 1/18; B32B 27/28

(52) U.S. Cl. CPC G09F 9/301; G06F 1/181; B32B 27/281; B32B 2457/20; B32B 2307/412; B32B 2307/536; B32B 2307/51

(57) ABSTRACT

Provided are flexible cover plate and a flexible display device. The flexible cover plate includes a transparent substrate, a hardened layer disposed on a surface of the transparent substrate, and a first brightness enhancement layer, a second brightness enhancement layer and an optical adhesive layer, which are sequentially disposed on the other surface of the transparent substrate; the hardened layer possesses a scratch and wear resistance function, and can effectively protect the flexible cover plate from damage; the first brightness enhancement layer and the second brightness enhancement layer are respectively configured to collect light in a first direction and a second direction, and the first direction and the second direction are perpendicular to each other, thus the lights passing through the two brightness enhancement layers are concentrated to the center of the flexible cover plate.

### FIELD OF THE INVENTION

The present invention relates to a display technology field, and more particularly to a flexible cover plate and a flexible display device.

### BACKGROUND OF THE INVENTION

With the advancement of information society, various requirements for display devices for displaying images are increasing. Recently, there are various display devices: a liquid crystal display device (LCD), a plasma display panel device (PDP), an organic light emitting display (OLED) device and the like can be illustrated.

Since liquid crystal display devices and organic light emitting display devices include thin film transistors have advantages of good resolution, color display and good image quality, these devices are widely used for display devices of televisions, notebook computers, tablet computers and desktop computers. In addition, these liquid crystal display devices and organic light emitting display devices including thin film transistors have been developed as flexible display devices having flexibility.

Unlike the glass cover of a general rigid screen, the flexible display device uses a flexible cover plate, which is bendable. When there is a softer material under the flexible cover plate, the flexible cover plate deforms with the optical adhesive layer as the external force is applied, and the surface hardness thereof is obviously decreased, which cannot meet the requirements of the displays. The reason is mainly because the optical adhesive layer is a viscoelastic material with no pressure resistance, and is easily and permanently deformed after being subjected to pressure, causing fine scratches on the surface of the flexible cover plate due to sagging, and lowering the surface hardness of the entire display device. Meanwhile, since the shape of the flexible display device is generally curved, the flexible display device has a wide viewing angle and a low center brightness, which often affects the customer experience. Therefore, there is a need for a flexible cover plate capable of solving the aforesaid problems.

### SUMMARY OF THE INVENTION

An objective of the present invention is to provide a flexible cover plate, possessing good brightness enhancement and scratch resistance, which can effectively enhance the market competitiveness of products.

Another objective of the present invention is to provide a flexible display, effectively improving a central brightness and possessing scratch resistance, which can effectively enhance the market competitiveness of products.

Fore realizing the aforesaid objectives, the present invention provides a flexible cover plate, comprising a transparent substrate, a hardened layer disposed on a surface of the transparent substrate, and a first brightness enhancement layer, a second brightness enhancement layer and an optical adhesive layer, which are sequentially disposed on the other surface of the transparent substrate;

wherein the first brightness enhancement layer and the second brightness enhancement layer are respectively configured to collect light in a first direction and a second direction to increase a central brightness, and the first direction and the second direction are perpendicular to each other.

The first direction and the second direction are parallel to the transparent substrate.

A surface of the first brightness enhancement layer and a surface of the second brightness enhancement layer are both provided with a plurality of brightness enhancement microstructures, and a shape of the brightness enhancement microstructures is a triangular prism; the plurality of brightness enhancement microstructures having a triangular prism shape on the first brightness enhancement layer extends in the second direction, and the plurality of brightness enhancement microstructures having a triangular prism shape on the second brightness enhancement layer extends in the first direction.

The transparent substrate is a transparent polyimide substrate.

The hardened layer is formed on the surface of the transparent substrate by a sputtering and evaporation process.

The present invention further provides a flexible display device, comprising a flexible panel and a flexible cover plate disposed on the flexible panel;

wherein the flexible cover plate comprises a transparent substrate, a hardened layer disposed on a surface of the transparent substrate, and a first brightness enhancement layer, a second brightness enhancement layer and an optical adhesive layer, which are sequentially disposed on the other surface of the transparent substrate;

wherein the first brightness enhancement layer and the second brightness enhancement layer are respectively configured to collect light in a first direction and a second direction, and the first direction and the second direction are perpendicular to each other.

The first direction and the second direction are parallel to the transparent substrate.

A surface of the first brightness enhancement layer and a surface of the second brightness enhancement layer are both provided with a plurality of brightness enhancement microstructures, and a shape of the brightness enhancement microstructures is a triangular prism; the plurality of brightness enhancement microstructures having a triangular prism shape on the first brightness enhancement layer extends in the second direction, and the plurality of brightness enhancement microstructures having a triangular prism shape on the second brightness enhancement layer extends in the first direction.

The transparent substrate is a transparent polyimide substrate.

The hardened layer is formed on the transparent substrate by a sputtering and evaporation process.

The benefits of the present invention are: the flexible cover plate provided by the present invention includes a transparent substrate, a hardened layer disposed on a surface of the transparent substrate, and a first brightness enhancement layer, a second brightness enhancement layer and an optical adhesive layer, which are sequentially disposed on the other surface of the transparent substrate; the hardened layer possesses a scratch and wear resistance function, and can effectively protect the flexible cover plate from damage; the first brightness enhancement layer and the second brightness enhancement layer are respectively configured to collect light in a first direction and a second direction, and the first direction and the second direction are perpendicular to each other, thus the lights passing through the two brightness enhancement layers are concentrated to the center of the flexible cover plate. As the flexible cover plate is applied in a flexible display device, the central brightness of the flexible display device can be improved. The flexible display device of the present invention includes the aforesaid flexible cover plate. The flexible cover plate includes a transparent substrate, a hardened layer disposed on a surface of the transparent substrate, and a first brightness enhancement layer, a second brightness enhancement layer and an optical adhesive layer, which are sequentially disposed on the other surface of the transparent substrate; the hardened layer possesses a scratch and wear resistance function, and can effectively protect the flexible cover plate from damage; the first brightness enhancement layer and the second brightness enhancement layer are respectively configured to collect light in a first direction and a second direction, and the first direction and the second direction are perpendicular to each other, thus the lights passing through the two brightness enhancement layers are concentrated to the center of the flexible cover plate. As the flexible cover plate is applied in a flexible display device. Therefore, the central brightness of the flexible display device of the present invention is higher and posses fine scratch resistance property.

### BRIEF DESCRIPTION OF THE DRAWINGS

In order to better understand the characteristics and technical aspect of the invention, please refer to the following detailed description and accompanying drawings of the present invention. However, the drawings are provided for reference only and are not intended to be limiting of the invention.

In drawings,

FIG. 1 is a structural diagram of a flexible cover plate according to the present invention;

FIG. 2 is a first direction view diagram of a first brightness enhancement layer of a flexible cover plate according to the present invention;

FIG. 3 is a second direction view diagram of a first brightness enhancement layer of a flexible cover plate according to the present invention;

FIG. 4 is a second direction view diagram of brightness enhancement microstructures of a first brightness enhancement layer of a flexible cover plate according to the present invention;

FIG. 5 is a first direction view diagram of a second brightness enhancement layer of a flexible cover plate according to the present invention;

FIG. 6 is a second direction view diagram of a second brightness enhancement layer of a flexible cover plate according to the present invention;

FIG. 7 is a first direction view diagram of brightness enhancement microstructures of a second brightness enhancement layer of a flexible cover plate according to the present invention;

FIG. 8 is a structural diagram of a flexible display device according to the present invention;

FIG. 9 is a diagram of a bent flexible display device according to the present invention.

### DETAILED DESCRIPTION OF PREFERRED EMBODIMENTS

For better explaining the technical solution and the effect of the present invention, the present invention will be further described in detail with the accompanying drawings and the specific embodiments.

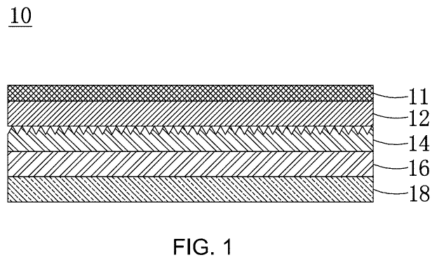

Please refer to FIG. 1. The present invention provides a flexible cover plate 10, comprising a transparent substrate 12, a hardened layer 11 disposed on a surface of the transparent substrate 12, and a first brightness enhancement layer 14, a second brightness enhancement layer 16 and an optical adhesive layer 18, which are sequentially disposed on the other surface of the transparent substrate 12; the hardened layer 11 possesses a scratch and wear resistance function, which can effectively protect the flexible cover plate 10 from damage; the optical adhesive layer 18 possesses good adhesion, so that the flexible cover plate 10 can be firmly adhered to the flexible panel with the optical adhesive layer 18.

The first brightness enhancement layer 14 and the second brightness enhancement layer 16 are respectively configured to collect light in a first direction and a second direction, and the first direction and the second direction are perpendicular to each other.

Specifically, the first direction and the second direction are parallel to the transparent substrate 12.

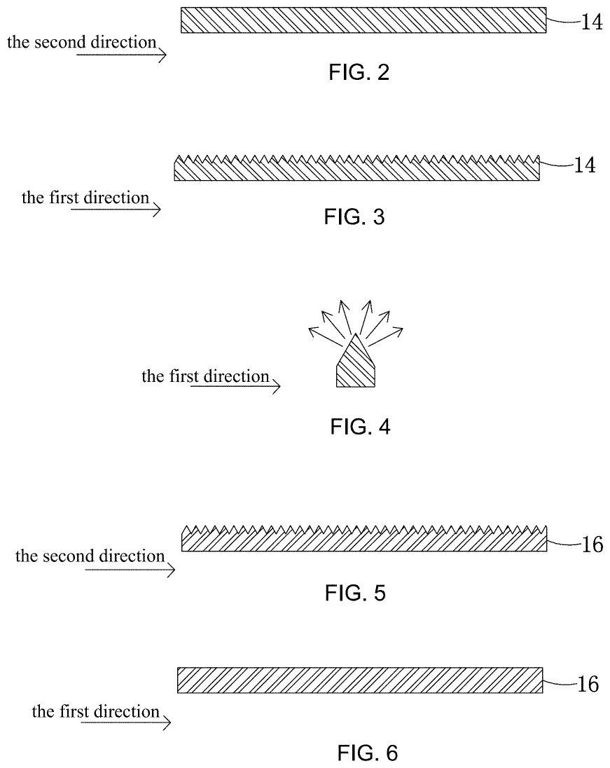

As shown in FIGS. 2 to 7, the flexible cover plate 10 of the present invention can collect the light in the first direction toward the center of the flexible cover plate 10 with the first brightness enhancement layer 14 and can collect the light in the second direction toward the center of the flexible cover plate 10 with the second brightness enhancement layer 16. The first direction and the second direction are perpendicular to each other. Thus, the lights passing through the two brightness enhancement layers are concentrated to the center of the flexible cover plate 10. As the flexible cover plate 10 is applied in a flexible display device, the central brightness of the flexible display device can be improved.

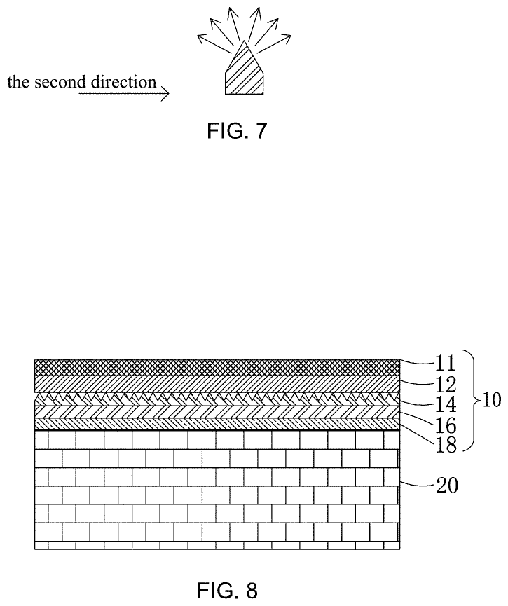

Specifically, as shown in FIG. 4 and FIG. 7, a surface of the first brightness enhancement layer 14 and a surface of the second brightness enhancement layer 16 are both provided with a plurality of brightness enhancement microstructures, and a shape of the brightness enhancement microstructures is a triangular prism. Furthermore, the plurality of brightness enhancement microstructures having a triangular prism shape on the first brightness enhancement layer 14 extends in the second direction, and the plurality of brightness enhancement microstructures extending in the second direction on the first brightness enhancement layer 14 can achieve a light collecting effect, so that the light is concentrated toward the center of the first brightness enhancement layer 14 in the first direction; the plurality of brightness enhancement microstructures having a triangular prism shape on the second brightness enhancement layer 16 extends in the first direction, and the plurality of brightness enhancement microstructures extending in the first direction on the second brightness enhancement layer 16 can achieve a light collecting effect, so that the light is concentrated toward the center of the second brightness enhancement layer 16 in the second direction. Specifically, on the first brightness enhancement layer 14 and the second brightness enhancement layer 16, the brightness enhancement microstructures having a triangular prism shape are protruded away from the optical adhesive layer 18.

It can be understood that the brightness enhancement microstructure can also be designed as a convex structure of other shapes as long as the convex-like lens structure with a low middle and high sides is satisfied for achieving the concentrating effect. For instance, the shape of the brightness enhancement microstructure can be a trapezoidal body. When the shape of the brightness enhancement microstructure is a trapezoidal body, the plurality of brightness enhancement microstructures having a trapezoidal body shape on the first brightness enhancement layer 14 extends in the second direction, and the plurality of brightness enhancement microstructures extending in the second direction on the first brightness enhancement layer 14 can achieve a light collecting effect, so that the light is concentrated toward the center of the first brightness enhancement layer 14 in the first direction; the plurality of brightness enhancement microstructures having a trapezoidal body shape on the second brightness enhancement layer 16 extends in the first direction, and the plurality of brightness enhancement microstructures extending in the first direction on the second brightness enhancement layer 16 can achieve a light collecting effect, so that the light is concentrated toward the center of the second brightness enhancement layer 16 in the second direction. Specifically, on the first brightness enhancement layer 14 and the second brightness enhancement layer 16, the brightness enhancement microstructures having a trapezoidal body shape are protruded away from the optical adhesive layer 18.

Specifically, the transparent substrate 12 is a transparent polyimide (PI) substrate.

Specifically, the hardened layer 11 is formed on the surface of the transparent substrate 12 by a sputtering and evaporation process. Since the transparent substrate 12 is a transparent PI substrate and PI possesses good high temperature resistance, thus, it is suitable for forming the hardened layer 11 on the transparent substrate 12 by the sputtering and evaporation process.

The foregoing flexible cover plate 10 includes a transparent substrate 12, a hardened layer 11 disposed on a surface of the transparent substrate 12, and a first brightness enhancement layer 14, a second brightness enhancement layer 16 and an optical adhesive layer 18, which are sequentially disposed on the other surface of the transparent substrate 12; the hardened layer 11 possesses a scratch and wear resistance function, and can effectively protect the flexible cover plate 10 from damage; the first brightness enhancement layer 14 and the second brightness enhancement layer 16 are respectively configured to collect light in a first direction and a second direction, and the first direction and the second direction are perpendicular to each other, thus the lights passing through the two brightness enhancement layers are concentrated to the center of the flexible cover plate 10. As the flexible cover plate 10 is applied in a flexible display device, the central brightness of the flexible display device can be improved.

Based on the flexible cover plate 10 described above, please refer to FIG. 8 in conjunction with FIGS. 1-7. The present invention further provides a flexible display device, comprising a flexible panel 20 and a flexible cover plate 10 disposed on the flexible panel 20;

wherein the flexible cover plate 10 comprises a transparent substrate 12, a hardened layer 11 disposed on a surface of the transparent substrate 12, and a first brightness enhancement layer 14, a second brightness enhancement layer 16 and an optical adhesive layer 18, which are sequentially disposed on the other surface of the transparent substrate 12; the hardened layer 11 possesses a scratch and wear resistance function, which can effectively protect the flexible cover plate 10 from damage, thereby indirectly functioning to protect the flexible panel 20; the optical adhesive layer 18 possesses good adhesion, so that the flexible cover plate 10 can be firmly adhered to the flexible panel 20 with the optical adhesive layer 18.

The first brightness enhancement layer 14 and the second brightness enhancement layer 16 are respectively configured to collect light in a first direction and a second direction, and the first direction and the second direction are perpendicular to each other.

Specifically, the first direction and the second direction are parallel to the transparent substrate 12.

As shown in FIGS. 2 to 7, the flexible cover plate 10 of the present invention can collect the light in the first direction toward the center of the flexible cover plate 10 with the first brightness enhancement layer 14 and can collect the light in the second direction toward the center of the flexible cover plate 10 with the second brightness enhancement layer 16. The first direction and the second direction are perpendicular to each other. Thus, the lights passing through the two brightness enhancement layers are concentrated to the center of the flexible cover plate 10. The central brightness of the flexible display device can be improved thereby.

Specifically, as shown in FIG. 4 and FIG. 7, a surface of the first brightness enhancement layer 14 and a surface of the second brightness enhancement layer 16 are both provided with a plurality of brightness enhancement microstructures, and a shape of the brightness enhancement microstructures is a triangular prism. Furthermore, the plurality of brightness enhancement microstructures having a triangular prism shape on the first brightness enhancement layer 14 extends in the second direction, and the plurality of brightness enhancement microstructures extending in the second direction on the first brightness enhancement layer 14 can achieve a light collecting effect, so that the light is concentrated toward the center of the first brightness enhancement layer 14 in the first direction; the plurality of brightness enhancement microstructures having a triangular prism shape on the second brightness enhancement layer 16 extends in the first direction, and the plurality of brightness enhancement microstructures extending in the first direction on the second brightness enhancement layer 16 can achieve a light collecting effect, so that the light is concentrated toward the center of the second brightness enhancement layer 16 in the second direction, thereby to effectively improve the central brightness of the flexible display device. Specifically, on the first brightness enhancement layer 14 and the second brightness enhancement layer 16, the brightness enhancement microstructures having a triangular prism shape are protruded away from the optical adhesive layer 18.

It can be understood that the brightness enhancement microstructure can also be designed as a convex structure of other shapes as long as the convex-like lens structure with a low middle and high sides is satisfied for achieving the concentrating effect. For instance, the shape of the brightness enhancement microstructure can be a trapezoidal body. When the shape of the brightness enhancement microstructure is a trapezoidal body, the plurality of brightness enhancement microstructures having a trapezoidal body shape on the first brightness enhancement layer 14 extends in the second direction, and the plurality of brightness enhancement microstructures extending in the second direction on the first brightness enhancement layer 14 can achieve a light collecting effect, so that the light is concentrated toward the center of the first brightness enhancement layer 14 in the first direction; the plurality of brightness enhancement microstructures having a trapezoidal body shape on the second brightness enhancement layer 16 extends in the first direction, and the plurality of brightness enhancement microstructures extending in the first direction on the second brightness enhancement layer 16 can achieve a light collecting effect, so that the light is concentrated toward the center of the second brightness enhancement layer 16 in the second direction. Specifically, on the first brightness enhancement layer 14 and the second brightness enhancement layer 16, the brightness enhancement microstructures having a trapezoidal body shape are protruded away from the optical adhesive layer 18.

Specifically, the transparent substrate 12 is a transparent PI substrate.

Specifically, the hardened layer 11 is formed on the surface of the transparent substrate 12 by a sputtering and evaporation process. Since the transparent substrate 12 is a transparent PI substrate and PI possesses good high temperature resistance, thus, it is suitable for forming the hardened layer 11 on the transparent substrate 12 by the sputtering and evaporation process.

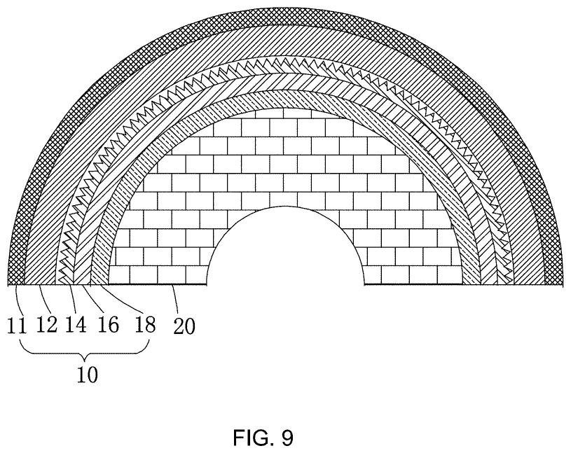

As shown in FIG. 9, as the flexible display device is bent, due to the presence of the hardened layer 11, the surface hardness and the pressure resistance of the flexible display device are higher, and it is not easy to cause slight scratches or scratches. Meanwhile, since the first brightness enhancement layer 14 and the second brightness enhancement layer 16 are respectively provided with microstructures collecting light in two mutually perpendicular directions, even if the light-emitting surface of the flexible display device is curved, the central brightness of the flexible display device can be ensured for not dropping to effectively improve the user experience.

The foregoing flexible cover plate 10 comprises a transparent substrate 12, a hardened layer 11 disposed on a surface of the transparent substrate 12, and a first brightness enhancement layer 14, a second brightness enhancement layer 16 and an optical adhesive layer 18, which are sequentially disposed on the other surface of the transparent substrate 12; the hardened layer 11 possesses a scratch and wear resistance function, which can effectively protect the flexible cover plate 10 from damage; the first brightness enhancement layer 14 and the second brightness enhancement layer 16 are respectively configured to collect light in a first direction and a second direction, and the first direction and the second direction are perpendicular to each other. Thus, the lights passing through the two brightness enhancement layers are concentrated to the center of the flexible cover plate 10. The central brightness of the flexible display device can be improved thereby.

In conclusion, the flexible cover plate of the present invention includes a transparent substrate, a hardened layer disposed on a surface of the transparent substrate, and a first brightness enhancement layer, a second brightness enhancement layer and an optical adhesive layer, which are sequentially disposed on the other surface of the transparent substrate; the hardened layer possesses a scratch and wear resistance function, and can effectively protect the flexible cover plate from damage; the first brightness enhancement layer and the second brightness enhancement layer are respectively configured to collect light in a first direction and a second direction, and the first direction and the second direction are perpendicular to each other, thus the lights passing through the two brightness enhancement layers are concentrated to the center of the flexible cover plate. As the flexible cover plate is applied in a flexible display device, the central brightness of the flexible display device can be improved. The flexible display device of the present invention includes the aforesaid flexible cover plate. The flexible cover plate includes a transparent substrate, a hardened layer disposed on a surface of the transparent substrate, and a first brightness enhancement layer, a second brightness enhancement layer and an optical adhesive layer, which are sequentially disposed on the other surface of the transparent substrate; the hardened layer possesses a scratch and wear resistance function, and can effectively protect the flexible cover plate from damage; the first brightness enhancement layer and the second brightness enhancement layer are respectively configured to collect light in a first direction and a second direction, and the first direction and the second direction are perpendicular to each other, thus the lights passing through the two brightness enhancement layers are concentrated to the center of the flexible cover plate. As the flexible cover plate is applied in a flexible display device. Therefore, the central brightness of the flexible display device of the present invention is higher and posses fine scratch resistance property.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A flexible cover plate, comprising a transparent substrate, a hardened layer disposed on a surface of the transparent substrate, and a first brightness enhancement layer, a second brightness enhancement layer and an optical adhesive layer, which are sequentially disposed on an other surface of the transparent substrate;
wherein the first brightness enhancement layer and the second brightness enhancement layer are respectively configured to collect light in a first direction and a second direction to increase a central brightness, and the first direction and the second direction are perpendicular to each other.

2. The flexible cover plate according to claim 1, wherein the first direction and the second direction are parallel to the transparent substrate.

3. The flexible cover plate according to claim 2, wherein a surface of the first brightness enhancement layer and a surface of the second brightness enhancement layer are both provided with a plurality of brightness enhancement microstructures, and a shape of the brightness enhancement microstructures is a triangular prism;
the plurality of brightness enhancement microstructures having a triangular prism shape on the first brightness enhancement layer extends in the second direction, and the plurality of brightness enhancement microstructures having a triangular prism shape on the second brightness enhancement layer extends in the first direction.

4. The flexible cover plate according to claim 1, wherein the transparent substrate is a transparent polyimide substrate.

5. The flexible cover plate according to claim 1, wherein the hardened layer is formed on the surface of the transparent substrate by a sputtering and evaporation process.

6. A flexible display device, comprising a flexible panel and a flexible cover plate disposed on the flexible panel;
wherein the flexible cover plate comprises a transparent substrate, a hardened layer disposed on a surface of the transparent substrate, and a first brightness enhancement layer, a second brightness enhancement layer and an optical adhesive layer, which are sequentially disposed on an other surface of the transparent substrate;
wherein the first brightness enhancement layer and the second brightness enhancement layer are respectively configured to collect light in a first direction and a second direction, and the first direction and the second direction are perpendicular to each other.

7. The flexible display device according to claim 6, wherein the first direction and the second direction are parallel to the transparent substrate.

8. The flexible display device according to claim 7, wherein a surface of the first brightness enhancement layer and a surface of the second brightness enhancement layer are both provided with a plurality of brightness enhancement microstructures, and a shape of the brightness enhancement microstructures is a triangular prism;
the plurality of brightness enhancement microstructures having a triangular prism shape on the first brightness enhancement layer extends in the second direction, and the plurality of brightness enhancement microstructures having a triangular prism shape on the second brightness enhancement layer extends in the first direction.

9. The flexible display device according to claim 6, wherein the transparent substrate is a transparent polyimide substrate.

10. The flexible display device according to claim 6, wherein the hardened layer is formed on the surface of the transparent substrate by a sputtering and evaporation process.
